(19) United States
(12) Patent Application Publication
(10) Pub. No.: US 2005/0208337 A1
(43) Pub. Date: Sep. 22, 2005

(54) Reduced thermal conductivity TBC by EB-PVD process to incorporate porosity

(76) Inventors: Nicholas E. Ulion, Marlborough, CT (US); Donald Broadhurst, East Hartford, CT (US); Michael J. Maloney, Marlborough, CT (US); Claude J. Clavette, Madawaska, ME (US); David A. Litton, Rocky Hill, CT (US); Mladen Trubelja, Manchester, CT (US)

Correspondence Address: BACHMAN & LAPOINTE, P.C., 900 CHAPEL STREET, SUITE 1201, NEW HAVEN, CT, 06510, US

(21) Appl. No.: 10/805,922

(22) Filed: Mar. 22, 2004

(51) Int. Cl. B32B 9/00

(52) U.S. Cl. 428/698; 428/702; 428/336; 428/304.4; 427/248.1

(57) ABSTRACT

A method for reducing thermal conductivity in thermal barrier coatings (TBC) through the incorporation of porosity comprising the steps of depositing a mixture comprising a TBC matrix and a fugitive material upon a part to form a layer, and heating the layer at a temperature and for a duration sufficient to liberate a portion of the fugitive material to form a porous network.

### BACKGROUND OF THE INVENTION

(1) Field of the Invention

The invention relates to a method for reducing thermal conductivity in coatings by increasing the porosity of the coating. More particularly, the invention relates to a method of increasing the porosity of a ceramic coating through the introduction of a fugitive material which is liberated when heat treated forming pores.

(2) Description of the Related Art

This invention relates to thermal barrier coatings (TBC) in general, and particularly to those made from ceramic materials, and to metallic parts having such thermal barrier coatings. The thermal barrier coatings have particular utility in gas turbine engines.

Gas turbine engines are well developed mechanisms for converting chemical potential energy, in the form of fuel, to thermal energy and then to mechanical energy for use in propelling aircraft, generating electrical power, pumping fluids, etc. At this time, the major available avenue for improved efficiency of gas turbine engines appears to be the use of higher operating temperatures. However, the metallic materials used in gas turbine engines components are currently very near the upper limits of their thermal stability. In the hottest portion of modern gas turbine engines, metallic materials are used at gas temperatures above their melting points. They survive because they are air cooled. But providing air cooling reduces engine efficiency.

Accordingly, there has been extensive development of thermal barrier coatings for use with cooled gas turbine aircraft hardware. By using a thermal barrier coating, the amount of cooling air required can be substantially reduced, thus providing a corresponding increase in efficiency.

One common thermal barrier coating (TBC) consists of a yttria stabilized zirconia ceramic known as 7YSZ. 7YSZ typically exhibits a thermal conductivity of approximately 2.2 W/m° C. It would be preferable to reduce this thermal conductivity to below 1.1 W/m° C, or about half of that of pure 7YSZ. Preferably the method chosen to accomplish such a diminution of thermal conductivity will not increase the mass of the coating. Because coatings are often applied to the airfoils of rotating parts, small increases in the mass of the coating can result in large forces being applied to the rotating part. Therefore, an ideal coating would couple reduced thermal conductivity with reduced mass.

### SUMMARY OF THE INVENTION

Accordingly, it is an object of the present invention to provide a method for reducing thermal conductivity in coatings by increasing the porosity of the coating. More particularly, the invention relates to a method of increasing the porosity of a ceramic coating through the introduction of a fugitive material which is liberated when heat treated forming pores.

In accordance with the present invention, a coating layer comprises a TBC matrix, and a porous network extending through the TBC matrix.

In further accordance with the present invention, a coated part comprises a part, and at least one layer applied to the part comprising a TBC matrix and a porous network.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a photograph of an exemplary combination of matrix TBC and fugitive material for use in EB-PVD according to the method of the present invention

FIG. 2 is a photomicrograph of the porosity formed in a 7YSZ coating utilizing a molybdenum fugitive material according to the method of the present invention.

FIG. 3 is a photomicrograph of the porosity formed in a 7YSZ coating utilizing a carbon fugitive material according to the method of the present invention.

Like reference numbers and designations in the various drawings indicate like elements.

### DETAILED DESCRIPTION

It is a teaching of the present invention to provide a method for creating a thermal barrier coating (TBC) with a reduced thermal conductivity resulting from the fabrication of a porous microstructure in the TBC. The porous structure is achieved through the co-evaporation of a fugitive material with the matrix TBC onto a part to be coated. Heat treatment of the co-evaporated deposition results in the liberation of the fugitive phase material leaving behind a porous network structure. The porous structure results in both a lowered thermal conductivity and reduced mass.

The matrix TBC may consist of any ceramic material that does not interact with the fugitive material in such a way that the fugitive material cannot be removed after deposition of the TBC. Preferred ceramics include carbides, nitrides, silicides, and zirconium based ceramics. In particular, yttria stabilized zirconia (7YSZ) is a widely used matrix TBC which is well suited to the method of the present invention.

As noted above, the method of the present invention involves the co-evaporation of a “matrix” TBC oxide along with a fugitive material in a predetermined ratio. Subsequent to co-evaporation, a post-coating, alloy friendly, oxidation heat treatment is used to liberate the fugitive material from the coating, leaving a porous structure. By “alloy friendly” it is meant that the maximum temperature at which the heat treatment is performed is below the melting temperature of the alloy from which the coated part is created. Preferably, the maximum temperature at which the heat treatment is performed is below the incipient melting point of any and all portions of the coated part exposed to the heat treatment. For the heat treatment of parts composed of nickel based alloys, maximum heat treatment temperatures typically range from 1750° F. to 2100° F.

It is required that the fugitive material be predominately stable in the deposition environment but easily removed (i.e. unstable) following the coating deposition step. The fugitive material must be compatible with the TBC oxide and the very high processing temperatures typical of EV-PVD coatings. By “compatible” it is meant that the fugitive material is not such as to alloy or diffuse into the TBC ceramic. While the present invention is therefore broadly drawn to encompass any and all compatible fugitive materials, three materials which form desired volatile decomposition products under typical post-coating heat exposure conditions, namely oxidation at a relatively low temperature in an atmospheric environment, are carbon, molybdenum and tungsten.

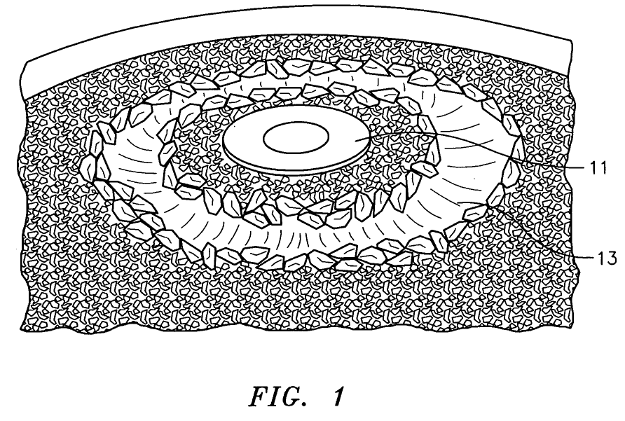

In practice, both the matrix TBC and the fugitive material are deposited in a layer or layers upon the part to be coated. Preferably, the matrix TBC and the fugitive material are deposited through a process of electron beam physical vapor deposition (EB-PVD). Various methods may be employed to achieve the deposition of the matrix TBC and the fugitive material in desired proportions. In one embodiment, particulate ceramic and a solid piece of fugitive material is utilized. Such an exemplary configuration is illustrated with reference to FIG. 1. Molybdenum disk 11 is surrounded, post EB-PVD, by solidified 7YSZ. During evaporation, an electron beam is directed in alternating fashion at the Molybdenum disk 11 and the particulate 7YSZ.

In another embodiment, preformed ingots of the matrix TBC and the fugitive material are utilized as the source of the coating vapor. In yet another embodiment, a single ingot composed of both the matrix and fugitive materials mixed in a predetermined ratio is vaporized and applied to coat a part forming a coating consisting of a similarly predetermined ratio of matrix material to fugitive material.

As a result of the method described above, a layer or multiple layers of a matrix TBC oxide and at least one fugitive material can be deposited upon a part. Each individual layer may contain a different percentage mixture of fugitive material resulting in a predetermined post-heating porosity. In one embodiment, there is alternatingly deposited upon the part at least one layer containing a fugitive material and at least one layer containing no fugitive material. As a result, post heat treatment, there exists at least one layer of the resulting TBC of a density undiminished by the liberation of a fugitive material.

The amount of porosity within a layer is controllable based on the ratio of fugitive to matrix material evaporated in the co-evaporation step. Microstructures, such as continuously porous or graded porosity coatings can also be produced. To produce graded porosity coatings, multi-source EB-PVD is performed whereby the intensity of the electron beam used to vaporize the fugitive material is varied in accordance with the desired amount of gradation. When employing a dual- or multi-source coating process, the initial and final layers of the deposited TBC may be of higher density or different composition then the matrix TBC (depending on the number of evaporation sources employed) to further enhance the characteristics of the TBC system. For example, selection of different material layers to optimize oxidation resistance, TBC adherence and erosion/impact resistance is possible. Such material layers may consist of, but are not limited to, yttria-stabilized zirconia or alumina.

### EXAMPLE

EB-PVD of 7YSZ as the matrix TBC oxide with either Carbon or Molybdenum as fugitives materials was successfully deposited in a layer upon a part made of a nickel-based alloy. Both materials proved sufficiently stable during the EB-PVD process environment to function in the desired manner. That is, they were co-evaporated, deposited and subsequently, removed (2050F/4 hour/air post-coat heat treatment) to produce a pore structure having a 27% volume fraction as compared to pure 7YSZ. The thermal conductivity was measured to be 1.1 W/m° C.

With reference to FIG. 1 there is illustrated the crucible configuration utilized to evaluate the EB-PVD fugitive phase process. The basic approach is the same for any of the above candidate fugitive materials. In the photograph, the molybdenum disc is located at the center of the crucible, surrounded by the ceramic particulate. The 7YSZ and fugitive materials are co-evaporated by manipulation of the electron beam. Alternating layers, of “dense” and “porous” TBC were evaporated. In addition, a coating deposition program was followed to provide initial and final application of dense (ie. “substantially pure”) 7YSZ, to promote TBC adherence and erosion resistance. Furthermore, the deposition program was modified to produce both a “continuous” and a “graded” porosity as described above.

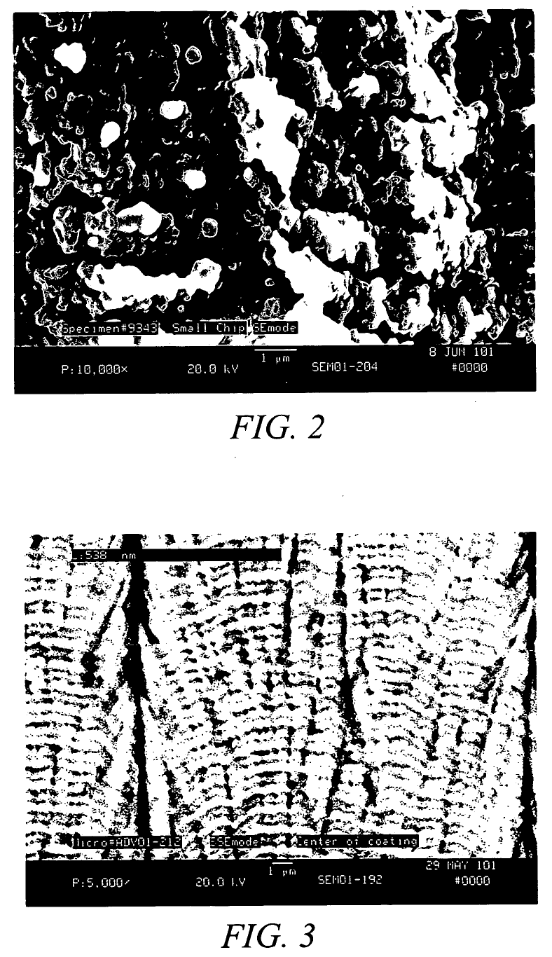

FIGS. 2 and 3 are SEM photomicrographs illustrating the type of 7YSZ coating microstructures achieved with molybdenum and carbon fugitives, respectively. As is visually apparent, the width of the individual pores formed using either fugitive is approximately between 10-100 nanometers. While individual pores measure approximately 10-100 nanometers in diameter, the total reduction in mass of the matrix TBC per unit volume was shown to range from 5% to 40%.

While a greater percentage reduction in the mass of the matrix TBC resulting from porosity results in greater reductions in thermal conductivity, there must be balanced a concern for the weakened physical properties of the TBC arising from the removal of fugitive materials. It is therefore preferred that a fugitive material be employed to provide an approximate pore size of between 10-100 nanometers in an amount sufficient to result, post liberation, in the removal of no more than 70% by weight of the matrix TBC. While a 100% evacuation of the fugitive material form the co-evaporated combination of the fugitive material and the matrix TBC is preferred, it is sufficient that at least 90% of the fugitive material is liberated and removed from the TBC.

While a similar approach may be feasible for a plasma spray process, because the substrate temperature is so much cooler in current APS ceramic processing, the current utilization of polyesters as a fugitive phase is adequate.

One or more embodiments of the present invention have been described. Nevertheless, it will be understood that various modifications may be made without departing from the spirit and scope of the invention. Accordingly, other embodiments are within the scope of the following claims.

1. A method for reducing thermal conductivity in thermal barrier coatings (TBC) through the incorporation of porosity comprising the steps of:
depositing a mixture comprising a TBC matrix and a fugitive material upon a part to form a layer; and
heating said layer at a temperature and for a duration sufficient to liberate a portion of said fugitive material to form a porous network.

2. The method of claim 1 wherein said depositing said TBC matrix comprises depositing a ceramic selected from the group consisting of 7YSZ, carbides, nitrides, silicides, and zirconium.

3. The method of claim 1 wherein said depositing said fugitive material comprises depositing a fugitive material selected from the group comprising carbon, molybdenum and tungsten.

4. The method of claim 1 wherein said depositing step comprises depositing said mixture comprising said TBC matrix and said fugitive material via an electron beam physical vapor deposition process (EB-PVD).

5. The method of claim 4 wherein said depositing said mixture via EB-PVD comprises utilizing particulate TBC matrix and particulate fugitive material.

6. The method of claim 4 wherein said depositing said mixture via EB-PVD comprises utilizing an ingot of said TBC matrix and an ingot of said fugitive material.

7. The method of claim 4 wherein said depositing said mixture via EB-PVD comprises utilizing a target comprised of an approximately uniform distribution of said TBC matrix and said fugitive material.

8. The method of claim 1 wherein said heating comprises heating said layer wherein said temperature is less than the melting temperature of the part.

9. The method of claim 1 wherein said heating comprises heating said layer wherein said temperature is less than the incipient melting point of the part.

10. The method of claim 1 wherein said heating comprises heating said layer wherein said temperature is between approximately 1750° F. and 2100° F.

11. The method of claim 10 wherein said heating comprises heating said layer at a temperature and for a duration sufficient to liberate at least 90% of said fugitive material.

12. The method of claim 1 comprising the additional step of depositing at least one layer of a TBC mixture substantially free of any fugitive material.

13. The method of claim 1 wherein said depositing said mixture comprises the steps of alerting the rate at which said TBC matrix and said fugitive material is deposited to form said layer and heating said layer to produce a layer having a gradation of porosity.

14. The method of claim 1 wherein said heating comprises heating said layer to produce said porous network comprising a volume not greater than 40% of said layer by volume.

15. The method of claim 1 wherein said depositing step comprises depositing said mixture upon a gas turbine engine component.

16. A coating layer comprising:
a TBC matrix; and
a porous network extending through said TBC matrix.

17. The coating of claim 16 wherein said TBC matrix is selected from the group consisting of 7YSZ, carbides, nitrides, silicides, and zirconium.

18. The coating of claim 16 wherein said porous network has a volume not greater than 40% of said TBC matrix by volume.

19. The coating of claim 16 wherein said porous network is of a graded porosity.

20. The coating of claim 16 wherein said porous network is comprised of a plurality of pores each having a width between ten and one hundred nanometers.

21. A coated part comprising:
a part; and
at least one layer applied to said part comprising a TBC matrix and a porous network.

22. The coated part of claim 20 wherein said TBC matrix is selected from the group consisting of 7YSZ, carbides, nitrides, silicides, and zirconium.

23. The coated part of claim 21 wherein said porous network is of a graded porosity.

24. The coated part of claim 21 wherein said porous network is comprised of a plurality of pores each having a width between ten and one hundred nanometers.

25. The coated part of claim 21 wherein said porous network has a volume not greater than 40% of said TBC matrix by volume.
